(19) United States
(12) Patent Application Publication
(10) Pub. No.: US 2004/0088740 A1
(43) Pub. Date: May 6, 2004

(54) Transmission-reception system

(76) Inventor: Johannes Maier, Sigmaringen (DE)

Correspondence Address: WOMBLE CARLYLE SANDRIDGE & RICE, P.O. Box 7037, Atlanta, GA, 30357-0037, US

(21) Appl. No.: 10/629,264

(22) Filed: Jul. 29, 2003

Related U.S. Application Data
(63) Continuation of application No. PCT/EP02/01012, filed on Jan. 31, 2002.

(30) Foreign Application Priority Data
Jan. 31, 2001 (EP) 01102243.1

(51) Int. Cl. H04N 7/00; H04N 11/00; H04N 7/16; H04N 7/173; G06F 13/00; H04N 5/445; G06F 3/00; H04N 7/10; H04N 7/025

(52) U.S. Cl. 725/135; 725/136; 725/112; 725/110; 348/460; 348/461; 725/37; 725/32

(57) ABSTRACT

The present invention relates to a transmission-reception system comprising a transmitter (12) configured to transmit digital data including a plurality of useful data as well as first auxiliary data associated with the useful data, and a receiver (14) configured to receive the digital data, having an output (58), at which useful data are able to be provided, wherein the first auxiliary data includes at least one first location-specific characteristic parameter; and the receiver (14) further includes a location specification unit (40), in which at least a second location-specific characteristic parameter is specifiable, and a feature association unit (52) associating a feature with the useful data, which corresponds to the degree of correlation of the first location-specific characteristic parameter contained in the associated auxiliary data with the second location-specific characteristic parameter. It further comprises a suitable transmitter (12) and a suitable receiver (14) as well as a corresponding method for transmitting digital data.

### CROSS-REFERENCE TO RELATED APPLICATIONS

This application is a continuation of PCT application no. PCT/EP02/01012 (designating the U.S.), filed on Jan. 31, 2002, which claims priority on European patent application number 01102243.1, filed on Jan. 31, 2001.

### INCORPORATION BY REFERENCE

The specification of PCT/EP02/01012 is incorporated herein in its entirety, by this reference.

### FIELD OF THE INVENTION

The present invention relates to a transmission-reception system according to the preamble of claim 1 as well as to a method for transmitting digital data according to the preamble of claim 15. Such a transmission-reception system and such a method are known from GB2344 009A.

### BACKGROUND OF THE INVENTION

The transmission of digital data from transmitters to receivers is known. In this context, recently, a new universal multimedia standard has been introduced, which is known under the designation DVB (Digital Video Broadcasting). The associated ETSI standards are present as the standards ETS 300421, ETS 300429 and ETS 300744. The term Digital Video Broadcasting includes a series of mutually compatible standards for digital television broadcasting via satellites, terrestrial transmitters and broadband cable networks. Image compression, error correction and adapted modulation methods allow for multiplication of the services being able to be offered with nearly error-free transmission on the available transmission paths.

The transition to the digital transmission technique allows for substantially more efficient use of the frequency spectrum as well as for more flexibility in dividing the transmission capacity. For the broadcast subscriber, this means an expansion of the program offer, for the program provider a decrease of the transmission cost per offered service.

The transmission-technical concepts differ depending on whether it is transmitted via cable, satellite or on terrestrial path. Thus, satellite broadcasting functions according to the so-called DVB-S, cable transmission according to the DVB-C and terrestrial transmission according to the DVB-T standard. Receivers can be specified to one of the transmission possibilities, but can also be formed so as to be able to receive signals, which have been transmitted via two or even all of the three transmission paths.

In other countries, for example in the USA and Japan, there are digital transmission-reception systems defined according to another standard, but principally functioning in comparable manner. The problems presented below are also inherent in these transmission-reception systems.

If, for example, it is to be listened to the radio via a satellite, the user of such a DVB receiver can select among a plurality of radio stations in the order of several hundreds. Now, the following problems exist:

With respect to the transmitter, there exists the danger that a local transmitting station, which for example addresses only a region of town, is lost in the plurality of offered radio stations, since its name is not as known as the one of some radio stations, which service wider areas. For the user of the DVB receiver, the problem exists that he has to view the plurality of the radio stations offered to him in order to select which program he wants to receive.

The already mentioned GB 2 344 009 A describes an apparatus for receiving transmitted data, wherein the receiver includes an information filter. This information filter allows only for selective data passage, wherein a portion of the transmitted data is filtered out according to a previously definable criterion. Therein, among other things, this criterion can be the location, at which the transmitted data is received. This means that only the transmitted data, which are relevant to the location of installation of the receiver, are passed from the receiver to the user. A user has the possibility of specifying the criterion according to his wishes, especially with respect to its personal profile. However, he has not the possibility of receiving transmitted data, which are transmitted for another local area.

Further, U.S. Pat. No. 5,565,909 describes various possibilities how geographic data can be filtered. Thereby, above all, the different informational interests of the users within a region are to be satisfied, which arise due to geographic characteristics. For example, information about flood tide or strong wind, which is only relevant to people living at a river or on the west side of a housing estate, belongs to that. This special geographic information is, even if for example broadcasted in the same town, only interesting for a special circle of people. This document aims to a filter providing the users only with the information relevant to them.

### SUMMARY OF THE INVENTION

Therefore, the object of the present invention is to provide a transmission-reception system, by which the described disadvantages can be avoided. It is also the object of the invention to provide a suitable transmitter and a suitable receiver as well as a corresponding transmission method.

According to the invention, this object is accomplished by a transmission-reception system having the features of claim 1, as well as by a method for transmitting digital data having the features of claim 15.

The invention is based on the recognition that for the user of the DVB receiver, certain transmitters are not interesting because they are local transmitters. Without doubt, for the user of the DVB receiver, local transmitters with locally adapted programs are interesting, but only those transmitting for his whereabouts. Therefore, a preselection can be made by comparing the location of installation of the DVB receiver with the received data, if location information is inherent to these data. Especially small broadcasting stations can thereby ensure that they won't be submerged in the plurality of often more popular broadcasting stations listed in long program tables. Rather, by this measure, it is managed in very simple manner to tell the user of the DVB receiver that the relevant transmitter transmits information, which could be of interest at the location of installation of the DVB receiver.

In this respect, it is preferred that the second location-specific characteristic parameter—herein, it can for example be the postal code of the location of installation—corresponds to the location of installation of the receiver or to a location arbitrarily selected by a user. Especially for portable receivers, it can be interesting that these can for example also be adjusted to a location other than the location of installation on holiday or on a trip.

For example, in transmitters covering wider areas, the first location-specific characteristic parameter can then have a country identification, which can then be further specified by adding the first number of the postal code, the second one, finally up to adding the fifth number of the postal code.

Moreover, second auxiliary data can be associated with the useful data, and the receiver can include a filter unit, by which the useful data are able to be filtered with respect to the second auxiliary data. By the second auxiliary data, for example musical preferences can be taken into account. Thus, it is unlikely that a confirmed classic fan is also interested in hard rock, so that it is useful for him—even if they are local hard rock broadcasting stations—not to offer these for selection. Generally, the second auxiliary data can contain indications to types of television broadcasts and/or types of music broadcasts and/or indications to Internet homepages and/or indications to commercials and events.

In order to accommodate the personal tastes of the operators of the receiver, it is preferred that each filter unit can be specified by an operator of the receiver. Especially, thereby it is made possible to accommodate varying wishes of the operators.

Preferably, the receiver further includes a display unit, on which a display correlated with the useful data is able to be presented. Herein, it can be a display unit integrated in the receiver, however also a computer screen or a television set. The display correlated with the useful data can then be able to be presented on the display unit according to the feature associated with the useful data. Preferably, the feature associated with the useful data includes a statement about whether and where the display correlated with the useful data is presented on the display unit. This means that for example a division of the different transmitters in various broadcasting areas can occur, for example in transmitters, which are worldwide interesting, transmitters, which are only interesting in Europe, and transmitters, which are only interesting in the town, in which the DVB receiver is installed. Herein, groups can be formed, wherein the user of the DVB receiver can select the transmitter desired by him among the groups, for example to directly listen to it or watch it, respectively, or to enter it in a preferred selection menu.

Further, the receiver can include an input unit, by which, preferably by cooperating with the display unit, the second location-specific characteristic parameter and/or the specifications of the feature association unit and/or the at least one filter unit are able to be specified.

As already mentioned, the digital data can have been transmitted to the receiver by satellite broadcasting, cable transmission, Internet transmission or terrestrial broadcasting.

The useful data can include audio signals and/or video signals and especially contain commercials and/or event indications. Thus, for example, the regionally addressed house radio listener hears about the local live performance of a corresponding band, the jazz fan the equivalent, and the DVB receiver tuned to the housewife program informs that in the supermarket around the corner is a special offer for bedside rugs. For example, this information can be broadcasted as screen information and can be derived from local editorial offices, which introduce into the transmission paths via any paths, for example via the Internet, automatically address and insert.

A fundamental advantage exists especially for the great television companies under public law and the private television companies, if they simultaneously switch-in several regional commercial blocks, wherein the one selected by the user is displayed by the DVB receiver. This makes broadcasting of commercials even via television transmitters also interesting for only regionally acting companies, which are able to selectively advertise, and now have to pay less for that (sharing of broadcasting time).

According to a second and a third aspect of the present invention, the invention also relates to a transmitter, which is formed so as to be employed in the transmission-reception system according to the invention, as well as to a corresponding receiver.

Further advantageous embodiments result from the dependent claims.

Other objects, features and advantages of the present invention will be understood by reference to and understanding of the following description with reference to the attached drawings.

### BRIEF DESCRIPTION OF THE DRAWINGS

Below, an embodiment of the transmission-reception system according to the invention is now described in more detailed with reference to the attached drawings.

FIG. 1 is an embodiment of a transmission-reception system according to the invention; and

FIG. 2 is in schematic illustration an exemplary display on the display unit of FIG. 1.

### DETAILED DESCRIPTION OF EXAMPLE EMBODIMENT

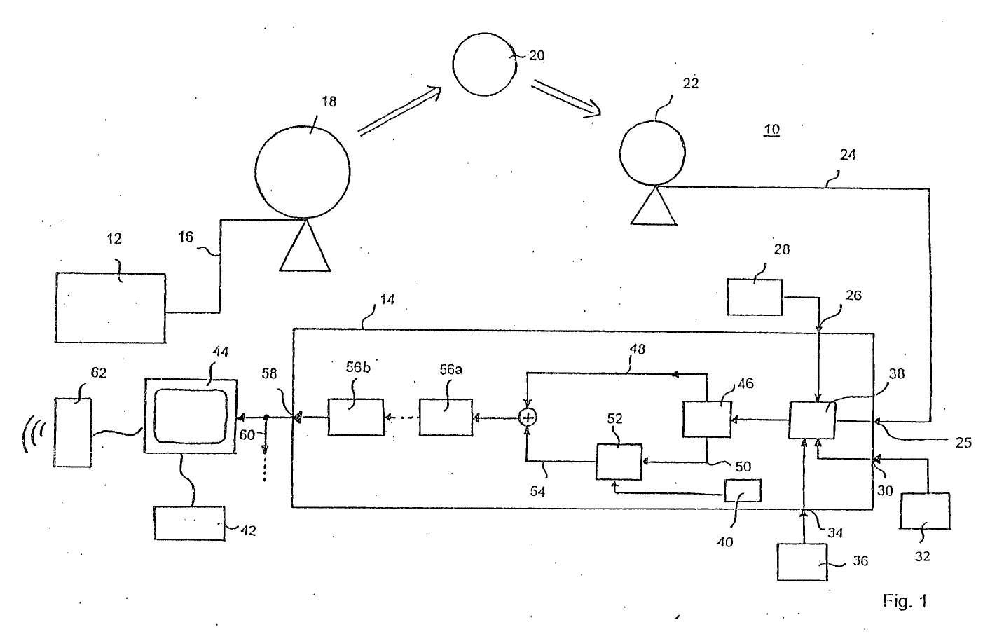

FIG. 1 shows in schematic illustration a transmission-reception system 10 according to the invention, including a transmitter 12 and a receiver 14. The transmitter transmits digital data to a transmitting station 18 through a line 16. As identified by the arrow, the digital data is first transmitted to a satellite 20, which reemits the data so that they can be received by a receiving unit 22. From the receiving unit 22, the data is transmitted to an input 25 of the receiver 14 through a line 24. Moreover, the receiver 14 has an input 26 for signals of a receiving unit 28 for terrestrially emitted signals, an input 30 for signals of a receiving unit 33 for signals transmitted through cable, as well as an input 34 for a receiving unit 36, which receives signals transmitted via the Internet. In the receiver 14, a transformation device 38 is disposed, which serves for transforming the signals provided at the inputs 25, 26, 30, 34 to a unitary format. A location specification unit 40 disposed in the receiver 14 serves for inputting a location-specific characteristic parameter into the receiver. Herein, it can for example be the postal code of the location of installation of the receiver 14 or the postal code of a location arbitrarily selected by a user. Instead of postal codes, for example also car identifications, synonyms for states, names of places, degrees of longitude and latitude etc. are considered.

The entry of the location-specific parameter into the location specification unit 40 of the receiver 14 can be effected in cooperation with an input unit 42 and a display unit 44, which are discussed below in greater detail.

Further, in the receiver 14, an auxiliary data acquisition unit 46 is disposed, into which the data transformed to a unitary format, composed of useful data and auxiliary data, is passed. In the auxiliary data acquisition unit 46, the useful data are separated from the auxiliary data, wherein the useful data are passed via path 48 and the auxiliary data are passed via path 50 to a feature association unit 52. In the feature association unit 52, the auxiliary data containing the location-specific characteristic parameter transmitted by the transmitter 12, are correlated with the data supplied by the location specification unit 40. According to the degree of correlation, a corresponding feature is associated with the useful data 48 via path 54. Further auxiliary data associated with the useful data, are evaluated in filter units 56a, 56b specifiable by the user of the receiver 14 after junction of the paths 48 and 54. The further auxiliary data can contain information to types of television broadcasts and/or types of music broadcasts and/or indications to Internet homepages and/or indications to events. For example, thereby, it can be ensured that only radio programs transmitting classic music are provided to the display unit 44. However, it can also be provided that according to setting of the filter units 56a, 56b or according to the feature associated in the feature association unit 52, respectively, the associated useful data are displayed on the display unit 44 with differing priority. At the output 58 of the receiver 14, useful data accordingly filtered and identified by features, respectively, are provided. For example, these can be provided to the display unit 44, however, as indicated by the arrow 60, also be transmitted to a television set, a radio set or the like. The display unit 44 can be a computer screen or a television set. However, it can also be provided to form the display unit 44 integrally with the receiver 14. Especially, it can be provided that the display unit 44 includes an amplifier and is immediately connected to a speaker 62.

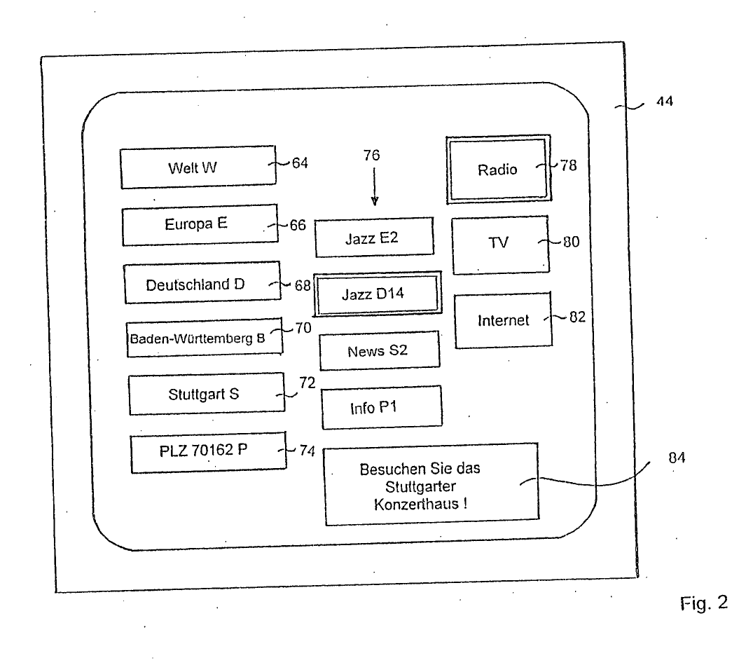

In FIG. 2, an example for the display on the display unit 44 is shown. In the illustrated example, the user of the receiver 14 has entered the postal code 70162 in the location specification unit 40. In a left area of the display, the transmitters received by the receiver 14 are divided in different local areas. Thus, by clicking on the icon 64 via the input unit 42 or by touching it on a touch screen, worldwide transmitters can be offered for selection, Europe-wide by the icon 66, German ones by the icon 68, transmitters in Baden-Württemberg by the icon 70, transmitters in the region of Stuttgart by the icon 72, and transmitters, which are interesting especially for the area with the postal code 70162, by the icon 74. By setting the filter units 56a, 56b, the user of the receiver 14 has ensured that no pop, rock or house programs are offered for selection. As is apparent from the display column 76, the user of the receiver 14 has specified the filter units 56a, 56b such that concerning the music offer only jazz programs are offered for selection, presently the second European transmitter E2 and the fourteenth German transmitter D14, which presently has been selected as indicated by the double frame. For the news, the user of the receiver 14 has selected the transmitter S2 of Stuttgart, as well as for information the postal code-specific transmitter P1.

By clicking on the icon 66, European transmitters are offered to the user of the receiver 14, which correspond to its presettings in the filter units 56a, 56b. Then he can select among these and add his preferred transmitters to column 76 for selection. Accordingly, by clicking on the icon 74, postal code-specific transmitters are offered to the user of the receiver 14 for selection.

By the icons 78, 80, 82, it can be switched between radio reception, television reception and Internet reception. Presently, as indicated by the double frame, the user has clicked on the icon 78 and thereby switched the receiver to radio operation.

As indicated by the window 84, despite of the reception of one program of the category “Germany”, i.e. a nationwide program, location-specific, i.e. regional, commercials can be displayed on the display 44.

The shown construction of the receiver 14 is to present only an exemplary realization. In an alternative embodiment, the useful data and the auxiliary data are not joined again after association of a feature, but separately further processed. The display unit 44 can also be a part of the apparatus, which is connected to the output 58 and the receiver 14, for example a radio display, the display of a television set etc.

Those skilled in the art will appreciate that modifications to the exemplary embodiments of the present invention are possible without departing from the spirit and scope of the present invention. Accordingly, the foregoing description of the exemplary embodiments is provided for the purpose of illustrating principles of the present invention and not in limitation thereof, since the spirit and scope of the present invention is ultimately defined by the claims.

1. Transmission-reception system comprising
a plurality of transmitters configured to transmit digital data including a plurality of useful data as well as first auxiliary data associated with the useful data, wherein the first auxiliary data includes at least one location-specific characteristic parameter;
a receiver configured to receive the digital data, having a location specification unit, in which at least a second location-specific characteristic parameter is specifiable, wherein the receiver has an output, at which useful data are able to be provided,
wherein the receiver further comprises:
a feature association unit associating a feature with the useful data, which corresponds to the degree of correlation of the first location-specific characteristic parameter contained in the associated auxiliary data with the second location-specific characteristic parameter,
characterized in that
the feature associated with the useful data allows for dividing the plurality of transmitters in groups of different broadcasting areas, wherein the user is able to select the transmitter(s) desired by him among the groups.

2. Transmission-reception system according to claim 1, characterized in that the second location-specific characteristic parameter corresponds to the location of installation of the receiver or to a location arbitrarily selected by a user.

3. Transmission-reception system according to claim 1, characterized in that second auxiliary data is associated with the useful data, and the receiver includes at least one filter unit, by which the useful data is filterable in view of the second auxiliary data.

4. Transmission-reception system according to claim 1, characterized in that the second auxiliary data are correlated with indications to types of television broadcasts and/or types of music broadcasts and/or indications to Internet homepages and/or indications to commercials and events.

5. Transmission-reception system according to any one of claims 3, characterized in that each filter unit can be specified by an operator of the receiver.

6. Transmission-reception system according to claim 1, characterized in that the receiver further comprises a display unit, on which a display correlated with the useful data is presentable.

7. Transmission-reception system according to claim 6, characterized in that the display correlated with the useful data is presentable on the display unit according to the feature associated with the useful data.

8. Transmission-reception system according to claim 1, characterized in that the feature associated with the useful data contains a statement about whether and where the display correlated with the useful data is presented on the display unit.

9. Transmission-reception system according to any one of claim 6, characterized in that the receiver further comprises an input unit, by which, preferably by cooperating with the display unit, the second location-specific characteristic parameter and/or the specifications of the feature association unit and/or the at least one filter unit are specifiable.

10. Transmission-reception system according to claim 1, characterized in that the digital data is transmitted to the receiver by satellite broadcasting, cable transmission, Internet transmission or terrestrial broadcasting.

11. Transmission-reception system according to claim 1, characterized in that the receiver is a DVB receiver.

12. Transmission-reception system according to claim 1, characterized in that the useful data comprises audio signals and/or video signals, and especially contains commercials and/or event indications.

13. Transmission-reception system according to any one of claims 4, characterized in that each filter unit can be specified by an operator of the receiver.

14. Receiver configured to receive digital data including a plurality of useful data as well as first auxiliary data associated with the useful data, wherein the first auxiliary data include at least one location-specific characteristic parameter, comprising a location specification unit, in which at least a second location-specific characteristic parameter is specifiable,
an output, at which useful data is able to be provided,
a feature association unit associating a feature with the useful data, which corresponds to the degree of correlation of the first location-specific characteristic parameter contained in the associated auxiliary data with the second location-specific characteristic parameter,
characterized in that
the feature associated with the useful data allows for dividing the plurality of transmitters in groups of different broadcasting areas, wherein the user is able to select the transmitter(s) desired by him among the groups on a display unit.

15. Method for transmitting digital data from at least one transmitter to at least one receiver including the steps of:
a) associating first auxiliary data with the useful data to be transmitted, wherein the first auxiliary data includes at least a first location-specific characteristic parameter;
b) transmitting the useful data and the associated first auxiliary data by at least one transmitter;
c) receiving the useful data and the associated first auxiliary data by at least one receiver (14);
d) in the receiver (14), correlating the first location-specific characteristic parameter contained in the received first auxiliary data with a second location-specific characteristic parameter specified in a location specification unit (40) of the receiver (14);
e) according to the degree of correlation, associating a feature with the associated useful data; characterized by the further step of:
f) dividing the plurality of transmitters in groups of different broadcasting areas based on the feature associated with the useful data, wherein the user is able to select the transmitter(s) desired by him among the groups.
